(19) United States
(12) Patent Application Publication
(10) Pub. No.: US 2026/0313420 A1
(43) Pub. Date: Oct. 8, 2026

(54) PERFORMANCE MONITORING ASSOCIATED WITH LOW-DENSITY REFERENCE SIGNAL PATTERNS

(71) Applicant: QUALCOMM Incorporated, San Diego, CA (US)

(72) Inventors: Rui HU, Beijing (CN); Chenxi HAO, Beijing (CN); Taesang YOO, San Diego, CA (US); Hao XU, Beijing (CN)

(21) Appl. No.: 19/478,356

(22) PCT Filed: Jul. 7, 2023
(86) PCT No.: PCT/CN2023/106262

§ 371 Date: Oct. 24, 2025

(51) Int. Cl. H04W 24/10; H04L 25/02; H04W 24/08

(52) U.S. Cl. CPC H04W 24/10; H04L 25/0202; H04W 24/08

(57) ABSTRACT

Various aspects of the present disclosure generally relate to wireless communication. In some aspects, a user equipment (UE) may obtain channel measurements associated with one or more measurement resources, wherein the one or more measurement resources are associated with a low-density reference signal pattern, and the one or more measurement resources are associated with one or more of an inference-based channel estimation or a performance monitoring. The UE may determine a key performance indicator (KPI) based at least in part on the channel measurements. The UE may transmit a report that indicates one or more of the KPI or the channel measurements. Numerous other aspects are described.

### FIELD OF THE DISCLOSURE

Aspects of the present disclosure generally relate to wireless communication and to techniques and apparatuses for performance monitoring associated with low-density reference signal patterns.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory; and one or more processors, coupled to the memory, configured to: obtain channel measurements associated with one or more measurement resources, wherein the one or more measurement resources are associated with a low-density reference signal pattern, and the one or more measurement resources are associated with one or more of an inference-based channel estimation or a performance monitoring; determine a key performance indicator (KPI) based at least in part on the channel measurements; and transmit a report that indicates one or more of the KPI or the channel measurements.

In some implementations, an apparatus for wireless communication at a network node includes a memory; and one or more processors, coupled to the memory, configured to: transmit a reference signal in accordance with a low-density reference signal pattern, wherein the reference signal is associated with one or more measurement resources, and the one or more measurement resources are associated with one or more of an inference-based channel estimation or a performance monitoring; and receive a report that indicates a KPI associated with channel measurements, wherein the channel measurements are associated with the one or more measurement resources.

In some implementations, a method of wireless communication performed by a UE includes obtaining channel measurements associated with one or more measurement resources, wherein the one or more measurement resources are associated with a low-density reference signal pattern, and the one or more measurement resources are associated with one or more of an inference-based channel estimation or a performance monitoring; determining a KPI based at least in part on the channel measurements; and transmitting a report that indicates one or more of the KPI or the channel measurements.

In some implementations, a method of wireless communication performed by a network node includes transmitting a reference signal in accordance with a low-density reference signal pattern, wherein the reference signal is associated with one or more measurement resources, and the one or more measurement resources are associated with one or more of an inference-based channel estimation or a performance monitoring; and receiving a report that indicates a KPI associated with channel measurements, wherein the channel measurements are associated with the one or more measurement resources.

In some implementations, a non-transitory computer-readable medium storing a set of instructions for wireless communication includes one or more instructions that, when executed by one or more processors of a UE, cause the UE to: obtain channel measurements associated with one or more measurement resources, wherein the one or more measurement resources are associated with a low-density reference signal pattern, and the one or more measurement resources are associated with one or more of an inference-based channel estimation or a performance monitoring; determine a KPI based at least in part on the channel measurements; and transmit a report that indicates one or more of the KPI or the channel measurements.

In some implementations, a non-transitory computer-readable medium storing a set of instructions for wireless communication includes one or more instructions that, when executed by one or more processors of a network node, cause the network node to: transmit a reference signal in accordance with a low-density reference signal pattern, wherein the reference signal is associated with one or more measurement resources, and the one or more measurement resources are associated with one or more of an inference-based channel estimation or a performance monitoring; and receive a report that indicates a KPI associated with channel measurements, wherein the channel measurements are associated with the one or more measurement resources.

In some implementations, an apparatus for wireless communication includes means for obtaining channel measurements associated with one or more measurement resources, wherein the one or more measurement resources are associated with a low-density reference signal pattern, and the one or more measurement resources are associated with one or more of an inference-based channel estimation or a performance monitoring; means for determining a KPI based at least in part on the channel measurements; and means for transmitting a report that indicates one or more of the KPI or the channel measurements.

In some implementations, an apparatus for wireless communication includes means for transmitting a reference signal in accordance with a low-density reference signal pattern, wherein the reference signal is associated with one or more measurement resources, and the one or more measurement resources are associated with one or more of an inference-based channel estimation or a performance monitoring; and means for receiving a report that indicates a KPI associated with channel measurements, wherein the channel measurements are associated with the one or more measurement resources.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of an artificial intelligence (AI)-based channel state information reference signal (CSI-RS) optimization, in accordance with the present disclosure.

FIG. 5 is a diagram illustrating an example of low-density CSI-RS patterns, in accordance with the present disclosure.

FIGS. 6-11 are diagrams illustrating examples associated with performance monitoring associated with low-density reference signal patterns, in accordance with the present disclosure.

FIGS. 12-13 are diagrams illustrating example processes associated with performance monitoring associated with low-density reference signal patterns, in accordance with the present disclosure.

FIGS. 14-15 are diagrams of example apparatuses for wireless communication, in accordance with the present disclosure.

### DETAILED DESCRIPTION

In an artificial intelligence (AI) or machine learning (ML) (AI/ML)-based reference signal optimization, a channel estimation neural network (ChanEst NN) may be trained with low-density reference signal patterns. The low-density reference signal may be a low-density channel state information reference signal (CSI-RS). After training, the channel estimation neural network may be used by a user equipment (UE) when a network node transmits the low-density reference signal. Transmitting the low-density reference signal may involve transmitting a reference signal in a reduced quantity of resource blocks (RBs) within a given resource. The AI/ML-based reference signal optimization may enable a relatively good channel estimation performance, but with a lower reference signal overhead.

Some channels may be recovered with the low-density reference signal, but other channels may require a higher density reference signal. For example, some channels may be associated with a larger number of multi-paths, and thus may require more reference signal observations. Channels that are associated with a fewer number of multi-paths may be able to be estimated using fewer reference signal observations. A network node may have a rough determination of a needed reference signal density based at least in part on measurements, but in some cases, a non-reciprocity between uplink and downlink channels may lead to an overestimate of a reference signal density or an underestimate of the reference signal density. In other words, in some cases, the network node may transmit a reference signal with a higher reference signal density than needed, which may waste signaling resources. In some cases, the network node may transmit a reference signal with a lower reference signal density than needed, which may result in a poor channel estimation performance. The poor channel estimation performance may degrade a performance of the UE and/or the network node. The UE may be unable to monitor whether a current configured reference signal density (e.g., CSI-RS density) is sufficient or insufficient to achieve a level of channel estimation performance that satisfies a threshold. Further, the UE may not be configured to support signaling needed to support monitoring and/or associated reporting to the network node.

Various aspects relate generally to performance monitoring associated with low-density reference signal patterns. Some aspects more specifically relate to performance monitoring associated with low-density CSI-RS patterns. In some examples, a network node may transmit, to a UE, a reference signal in accordance with a low-density reference signal pattern. For example, the reference signal may be a CSI-RS, and the low-density reference signal pattern may be a low-density CSI-RS pattern. The reference signal may be associated with one or more measurement resources. The one or more measurement resources may be associated with an inference-based channel estimation (e.g., a channel estimation resource) and/or a performance monitoring (e.g., a monitoring resource). The UE may obtain channel measurements associated with the one or more measurement resources. The channel measurements may include channel measurements associated with the inference-based channel estimation and/or channel measurements associated with the performance monitoring. The channel measurements associated with the performance monitoring may be used to cross check or validate the channel measurements associated with the inference-based channel estimation. The UE may determine a key performance indicator (KPI) based at least in part on the channel measurements. For example, the KPI may be based at least in part on a normalized mean square error (NMSE) associated with the channel measurements (e.g., the channel measurements associated with the inference-based channel estimation and/or the channel measurements associated with the performance monitoring). The UE may transmit, to the network node, a report that indicates the KPI, the channel measurements, channel state information (CSI) derived from the channel measurements, and/or a one-bit indication that indicates whether a density of the low-density reference signal pattern satisfies a threshold. The one-bit indication may be based at least in part on the KPI and/or the channel measurements. The network node may adjust a density of the low-density reference signal pattern based at least in part on the report. For example, the network node may increase or decrease the density of the low-density reference signal pattern based at least in part on the report.

Particular aspects of the subject matter described in this disclosure can be implemented to realize one or more of the following potential advantages. In some examples, by implementing performance monitoring in an AI/ML-based reference signal optimization for channel estimation, the described techniques can be used to adjust the density of the low-density reference signal pattern to improve a channel estimation performance and/or reduce a signaling overhead. The UE may determine whether the channel estimation (e.g., an AI/ML-based channel estimation) is adequate, and whether a density pattern of the reference signal should be increased or decreased depending on whether the channel estimation is adequate. The UE may increase the density pattern of the reference signal depending on a cross-check between an estimated channel and a monitored channel, which may improve an overall performance of the UE and/or the network node (e.g., an improved channel estimation performance). The UE may decrease the density pattern of the reference signal depending on the cross-check between the estimated channel and the monitored channel, which may reduce the signaling overhead for the UE and/or the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

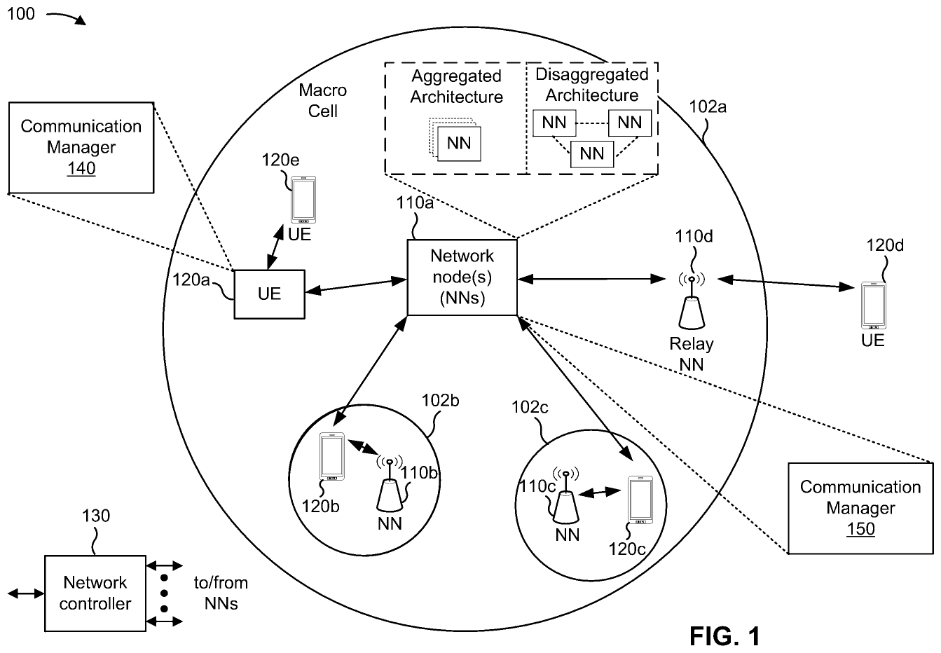

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may obtain channel measurements associated with one or more measurement resources, wherein the one or more measurement resources are associated with a low-density reference signal pattern, and the one or more measurement resources are associated with one or more of an inference-based channel estimation or a performance monitoring; determine a KPI based at least in part on the channel measurements; and transmit a report that indicates one or more of the KPI or the channel measurements. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit a reference signal in accordance with a low-density reference signal pattern, wherein the reference signal is associated with one or more measurement resources, and the one or more measurement resources are associated with one or more of an inference-based channel estimation or a performance monitoring; and receive a report that indicates a KPI associated with channel measurements, wherein the channel measurements are associated with the one or more measurement resources. Additionally, or alternatively, the communication manager 150 may perform one or more other operations described herein.

As indicated above, FIG. 1 is provided as an example. Other examples may differ from what is described with regard to FIG. 1.

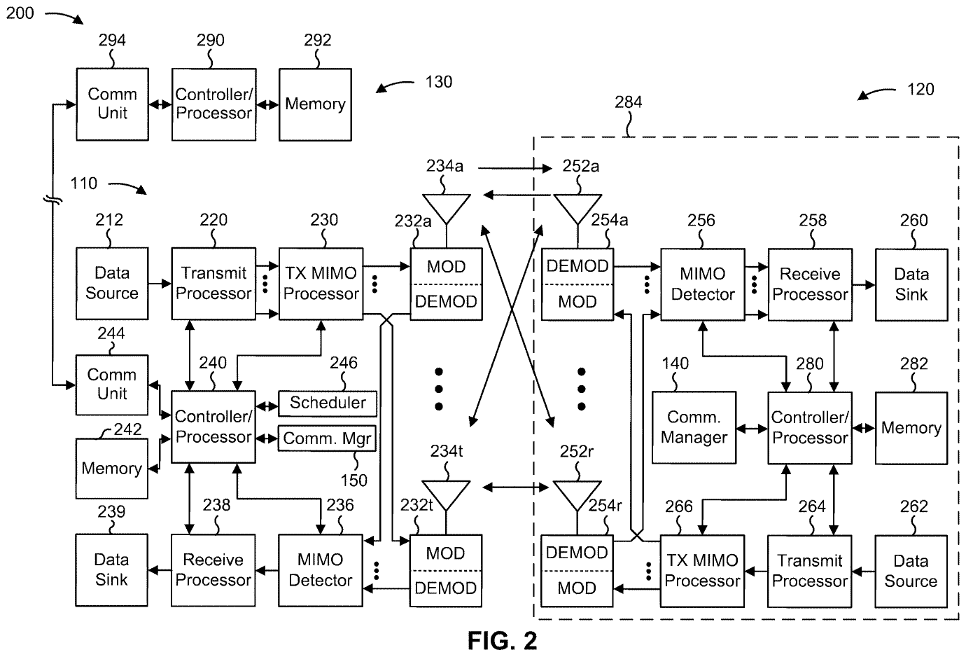

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

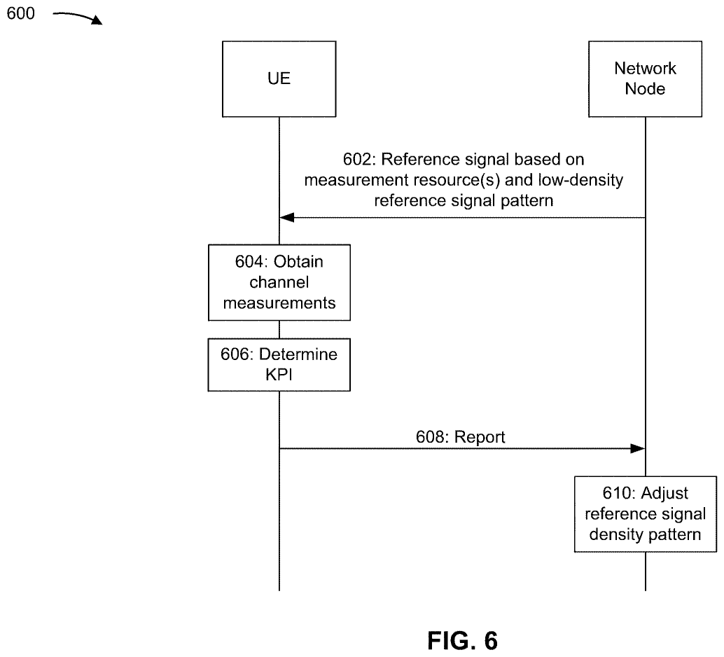

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-15).

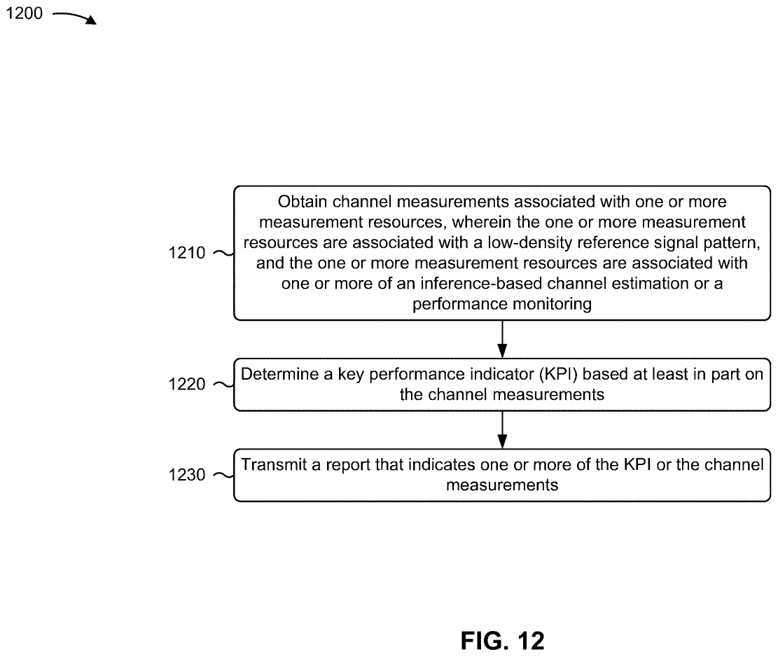

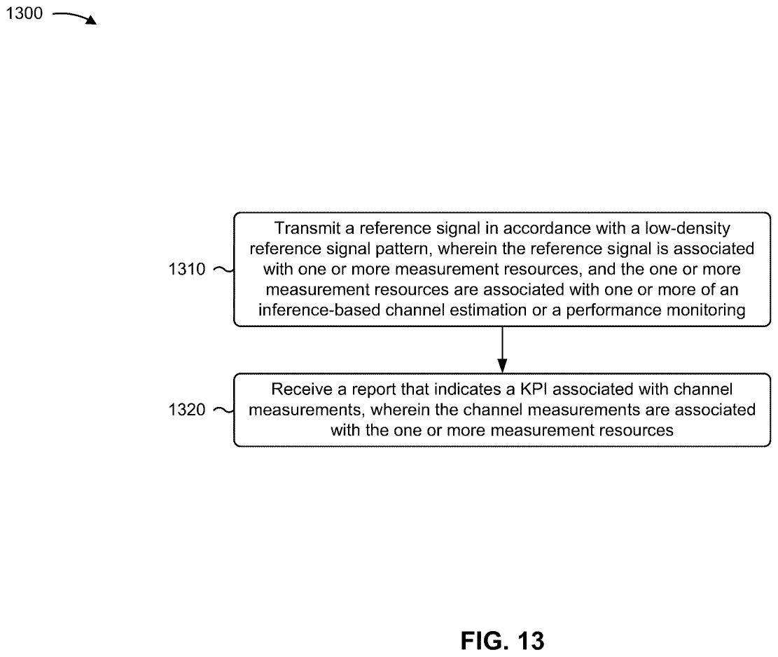

The controller/processor 240 of the network node 110, the controller/processor 280 of the UE 120, and/or any other component(s) of FIG. 2 may perform one or more techniques associated with performance monitoring associated with low-density reference signal patterns, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a UE (e.g., the UE 120) includes means for obtaining channel measurements associated with one or more measurement resources, wherein the one or more measurement resources are associated with a low-density reference signal pattern, and the one or more measurement resources are associated with one or more of an inference-based channel estimation or a performance monitoring; means for determining a KPI based at least in part on the channel measurements; and/or means for transmitting a report that indicates one or more of the KPI or the channel measurements. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting a reference signal in accordance with a low-density reference signal pattern, wherein the reference signal is associated with one or more measurement resources, and the one or more measurement resources are associated with one or more of an inference-based channel estimation or a performance monitoring; and/or means for receiving a report that indicates a KPI associated with channel measurements, wherein the channel measurements are associated with the one or more measurement resources. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

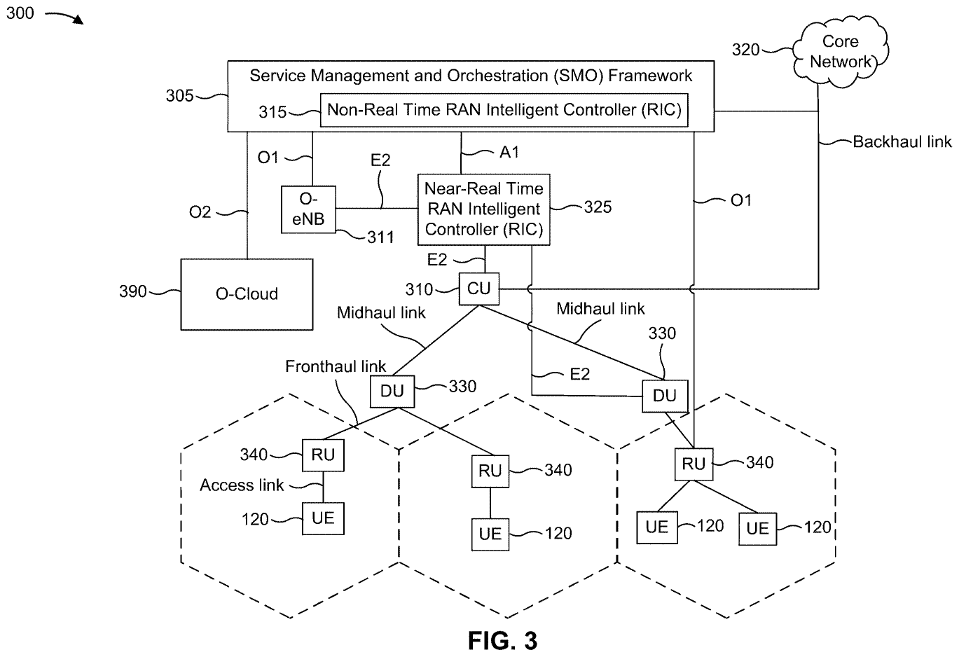

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, AI/ML workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

In an AI/ML-based CSI-RS optimization, a ChanEst NN may be trained with low-density CSI-RS patterns. After training, the channel estimation neural network may be used by a UE when a network node transmits a low-density CSI-RS. A low-density CSI-RS may involve transmitting a CSI-RS in a reduced quantity of RBs within a given resource. The AI/ML-based CSI-RS optimization may enable a relatively good channel estimation performance, but with a lower CSI-RS overhead.

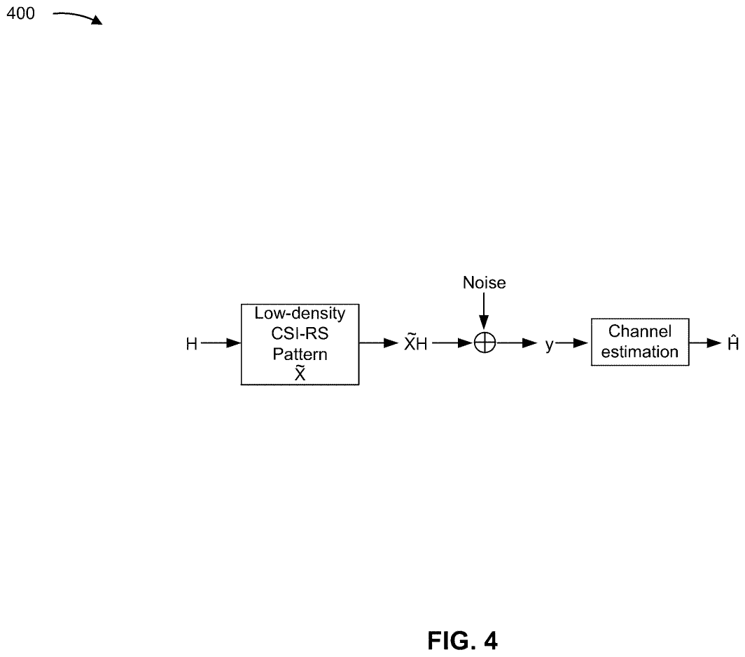

FIG. 4 is a diagram illustrating an example 400 of an AI-based CSI-RS optimization, in accordance with the present disclosure.

As shown in FIG. 4, a network node may transmit a low-density CSI-RS in accordance with a low-density CSI-RS pattern ω̋ over a channel ″O (e.g., ω̋″O). The channel may be associated with noise. A UE may observe a received signal (\acute{ω}) and perform a channel estimation (″O). The UE may perform the channel estimation using a channel estimation neural network deployed at the UE. The channel estimation neural network may be associated with an AI-based CSI-RS optimization. The channel estimation neural network may be trained with low-density CSI-RS patterns. As a result, even though the network node may transmit the low-density CSI-RS, the UE may be able to obtain a decent channel estimation performance (e.g., a channel estimation performance that satisfies a defined threshold) by using the channel estimation neural network.

As indicated above, FIG. 4 is provided as an example. Other examples may differ from what is described with regard to FIG. 4.

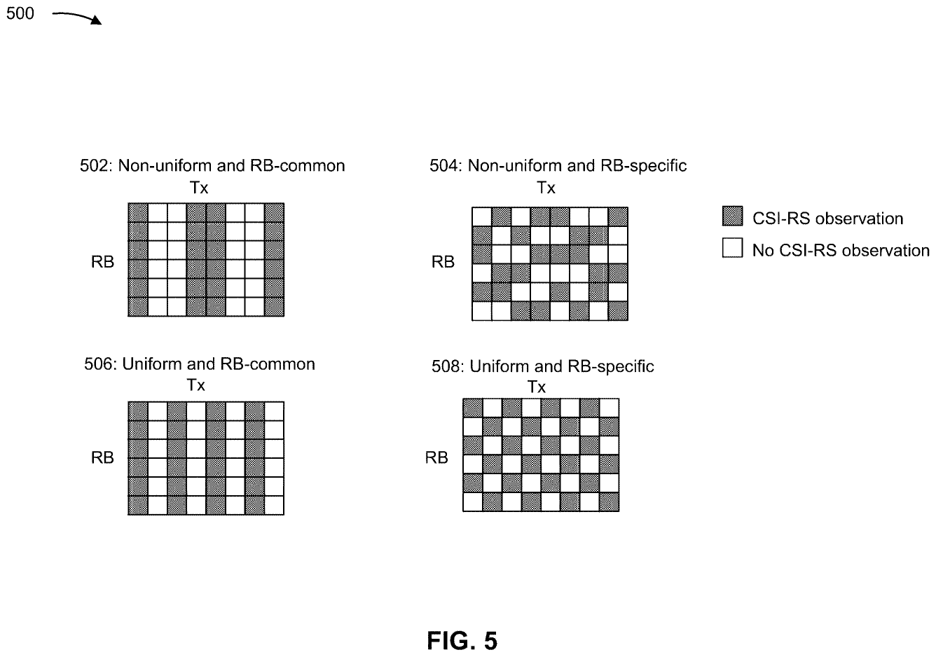

FIG. 5 is a diagram illustrating an example 500 of low-density CSI-RS patterns, in accordance with the present disclosure.

As shown by reference number 502, a low-density CSI-RS pattern may be a non-uniform and RB-common low-density CSI-RS pattern. As shown by reference number 504, a low-density CSI-RS pattern may be a non-uniform and RB-specific low-density CSI-RS pattern. As shown by reference number 506, a low-density CSI-RS pattern may be a uniform and RB-common low-density CSI-RS pattern. As shown by reference number 508, a low-density CSI-RS pattern may be a uniform and RB-specific low-density CSI-RS pattern. Further, a low-density CSI-RS pattern may be a transmit (Tx)-RB pattern.

As indicated above, FIG. 5 is provided as an example. Other examples may differ from what is described with regard to FIG. 5.

Some channels may be recovered with a low-density CSI-RS, but other channels may require a higher density CSI-RS. For example, some channels may be associated with a larger number of multi-paths, and thus may require more CSI-RS observations. Channels that are associated with a fewer number of multi-paths may be able to be estimated using fewer CSI-RS observations. A network node may have a rough determination of a needed CSI-RS density based at least in part on sounding reference signal (SRS) measurements, but in some cases, a non-reciprocity between uplink and downlink channels may lead to an overestimate of a CSI-RS density or an underestimate of the CSI-RS density. In other words, in some cases, the network node may transmit a CSI-RS with a higher CSI-RS density than needed, which may waste signaling resources. In some cases, the network node may transmit a CSI-RS with a lower CSI-RS density than needed, which may result in a poor channel estimation performance. The poor channel estimation performance may degrade a performance of the UE and/or the network node. A UE may be unable to monitor whether a current configured reference signal density (e.g., CSI-RS density) is sufficient or insufficient to achieve a level of channel estimation performance that satisfies a threshold. Further, the UE may not be configured to support signaling needed to support monitoring and/or associated reporting to the network node.

In various aspects of techniques and apparatuses described herein, a network node may transmit, to a UE, a reference signal in accordance with a low-density reference signal pattern. For example, the reference signal may be a CSI-RS, and the low-density reference signal pattern may be a low-density CSI-RS pattern. The reference signal may be associated with one or more measurement resources. The one or more measurement resources may be associated with an inference-based channel estimation (e.g., a channel estimation resource) and/or a performance monitoring (e.g., a monitoring resource). The UE may obtain channel measurements associated with the one or more measurement resources. The channel measurements may include channel measurements associated with the inference-based channel estimation and/or channel measurements associated with the performance monitoring. The channel measurements associated with the performance monitoring may be used to cross check or validate the channel measurements associated with the inference-based channel estimation. The UE may determine a KPI based at least in part on the channel measurements. For example, the KPI may be based at least in part on an NMSE associated with the channel measurements (e.g., the channel measurements associated with the inference-based channel estimation and/or the channel measurements associated with the performance monitoring). The UE may transmit, to the network node, a report that indicates the KPI, the channel measurements, CSI derived from the channel measurements, and/or a one-bit indication that indicates whether a density of the low-density reference signal pattern satisfies a threshold. The one-bit indication may be based at least in part on the KPI and/or the channel measurements. The network node may adjust a density of the low-density reference signal pattern based at least in part on the report. For example, the network node may increase or decrease the density of the low-density reference signal pattern based at least in part on the report.

In some aspects, performance monitoring may be implemented in an AI/ML-based reference signal optimization for channel estimation. The network node may transmit the reference signal on the monitoring resource, which may be used by the UE to cross-check the channel estimation using the channel estimation resource. The UE may determine whether the channel estimation (e.g., an AI/ML-based channel estimation) is adequate, and whether a density pattern of the reference signal should be increased or decreased depending on whether the channel estimation is adequate. The UE may increase the density pattern of the reference signal depending on the cross-check between an estimated channel and a monitored channel, which may improve an overall performance of the UE and/or the network node (e.g., an improved channel estimation performance). The UE may decrease the density pattern of the reference signal depending on the cross-check between the estimated channel and the monitored channel, which may reduce a signaling overhead for the UE and/or the network node.

FIG. 6 is a diagram illustrating an example 600 associated with performance monitoring associated with low-density reference signal patterns, in accordance with the present disclosure. As shown in FIG. 6, example 600 includes communication between a UE (e.g., UE 120) and a network node (e.g., network node 110). In some aspects, the UE and the network node may be included in a wireless network, such as wireless network 100.

As shown by reference number 602, the network node may transmit, to the UE, a reference signal in accordance with a low-density reference signal pattern. For example, the reference signal may be a CSI-RS, and the low-density reference signal pattern may be a low-density CSI-RS pattern. The low-density reference signal pattern may be used to reduce a signaling overhead associated with the reference signal. The low-density reference signal pattern may include RBs associated with reference signal observations and RBs that are not associated with reference signal observations, which may reduce the signaling overhead.

In some aspects, the reference signal may be associated with one or more measurement resources. The one or more measurement resources may be associated with an inference-based channel estimation (e.g., a channel estimation resource) and/or a performance monitoring (e.g., a monitoring resource). The inference-based channel estimation may be an AI/ML-based channel estimation.

As shown by reference number 604, the UE may obtain channel measurements associated with the one or more measurement resources. The channel measurements may include channel measurements associated with the inference-based channel estimation and/or channel measurements associated with the performance monitoring. The channel measurements associated with the performance monitoring resource may be used to cross check or validate the channel measurements associated with the channel estimation resource. In other words, the inference-based channel estimation may be validated based at least in part on the channel measurements associated with the performance monitoring resource.

As shown by reference number 606, the UE may determine a KPI based at least in part on the channel measurements. For example, the KPI may be based at least in part on an NMSE associated with the channel measurements, which may include the channel measurements associated with the inference-based channel estimation and/or the channel measurements associated with the performance monitoring.

In some aspects, the one or more measurement resources may include a single resource (e.g., only a single resource) associated with the inference-based channel estimation and the performance monitoring. A first portion of the single resource may be associated with the inference-based channel estimation and a remaining portion of the single resource may be associated with the performance monitoring. The UE may determine the KPI based at least in part on channel measurements associated with the first portion of the single resource and channel measurements associated with the remaining portion of the single resource.

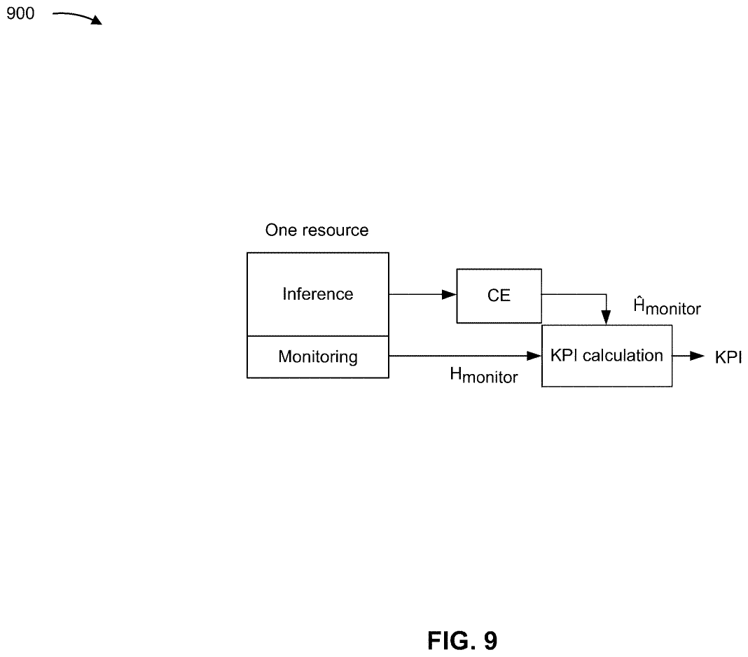

In some aspects, in a first option, one resource may be associated with one CSI-RS occasion (e.g., as shown in FIG. 9). The UE may use a partial resource (e.g., a portion of the one resource) for channel estimation (or inference). The UE may use a remaining resource (e.g., a remaining portion of the one resource) for monitoring. The UE may obtain channel measurements based at least in part on the partial resource. The UE may obtain channel measurements based at least in part on the remaining resource. The UE may calculate the KPI based at least in part on NMSE(″O−″O) , where ″O is associated with an estimated monitored channel and ″O is associated with a monitored channel.

In some aspects, the one or more measurement resources may include a first resource associated with the inference-based channel estimation and a second resource associated with the performance monitoring. The UE may determine the KPI based at least in part on channel measurements associated with the first resource and channel measurements associated with the second resource. The second resource may include physical resources that are not included in the first resource. The first resource may be independent from the second resource. Alternatively, the first resource may be paired with the second resource.

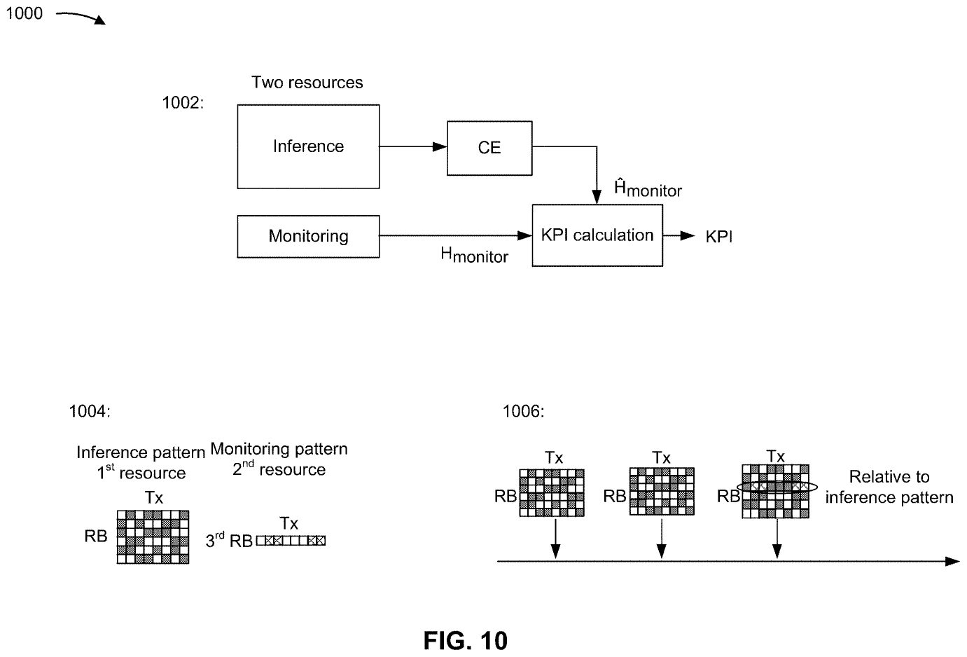

In some aspects, in a second option, the first resource may be associated with channel estimation (or inference) and the second resource may be associated with monitoring (e.g., as shown in FIG. 10). The first resource and the second resource may be CSI-RS resources. The second resource for monitoring may contain physical resources that are not included in the first resource for channel estimation (e.g., a monitoring resource may at least contain physical resources that are not included in an inference resource). The UE may obtain channel measurements based at least in part on the first resource. The UE may obtain channel measurements based at least in part on the second resource. The UE may calculate the KPI based at least in part on NMSE(″O−″O) . In some aspects, a configuration or an association of the two resources may be independent or paired. In other words, the first resource may be independent from the second resource, or alternatively, the first resource may be paired with the second resource.

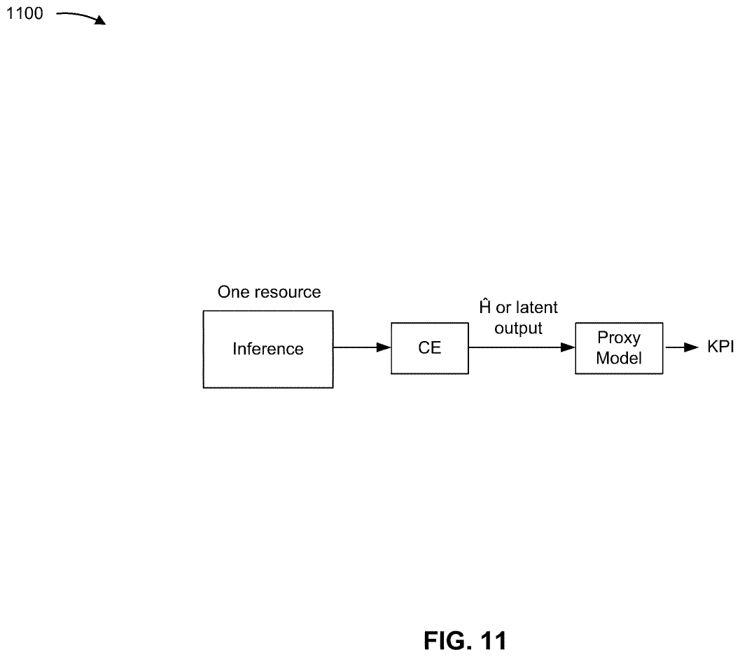

In some aspects, the one or more measurement resources may include a single resource associated with only the inference-based channel estimation. The UE may determine the KPI based at least in part on channel measurements associated with the single resource and a proxy model. In some aspects, in a third option, one resource for channel estimation (or inference) and a proxy model may be used to output the KPI (e.g., as shown in FIG. 11). The one resource may be a CSI-RS resource. An input of the proxy model for KPI calculation may be an estimated channel (″O) or a latent output. The UE may calculate the KPI based at least in part on the output of the proxy model.

As shown by reference number 608, the UE may transmit, to the network node, a report that indicates the KPI, the channel measurements, CSI derived from the channel measurements, and/or a one-bit indication that indicates whether a density of the low-density reference signal pattern satisfies a threshold. The one-bit indication may be based at least in part on the KPI and/or the channel measurements.

In some aspects, the report may be a network-node-controlled report. The report may be a periodic report, a semi-persistent report, or an aperiodic report. In some aspects, the report may be a UE-initiated report or an event-triggered report. The event-triggered report may be based at least in part on the KPI satisfying a threshold, and the threshold may be configured by the network node or predefined in a standard. The event-triggered report may be based at least in part on a number of events, in which the KPI is below a first threshold, satisfying a second threshold. In some cases, the report may be a first report, and the UE may refrain from transmitting a second report until an expiry of a timer.

In some aspects, the UE may report the KPI to the network node, irrespective of whether the KPI is calculated using the first option, the second option, or the third option. The KPI may be associated with a performance monitoring for an AI/ML-based CSI-RS optimization. The UE may report channel measurements to the network node, where the channel measurements may be associated with the partial resource and the remaining resource, or the channel measurements may be associated with the first resource and the second resource, respectively. The UE may report CSI generated by the channel measurements to the network node. The UE may report the one-bit indication together or separately with the KPI reporting. The one-bit indication may indicate whether the channel measurements are sufficient or insufficient, which may indicate whether a CSI-RS density is sufficient or insufficient (e.g., a bit value of “1” may indicate sufficient and a bit value of “0” may indicate insufficient, or vice versa).

In some aspects, the performance monitoring and the KPI reporting may be controlled by the network node. The network node may configure or trigger, for the UE, a dedicated CSI-RS resource for monitoring. A monitoring report by the UE may be periodic, semi-persistent, or aperiodic. The UE may transmit, to the network node, the monitoring report, which may indicate the KPI calculation, the channel measurements, and/or the one-bit indication.

In some aspects, the KPI reporting may be UE initiated or event triggered. The UE may perform the KPI reporting based at least in part on the KPI satisfying the threshold (e.g., when the KPI is lower than the threshold). The threshold may be configured by the network node or predefined in the specification. The UE may average the KPI over a monitor window, and when the averaged KPI satisfies the threshold, the UE may perform the KPI reporting. The UE may perform the KPI reporting when a number of events in which the KPI is below a first threshold is over a second threshold (e.g., #(KPI<threshold_1)>threshold_2). In other words, when the KPI is below a defined threshold a certain number of times, the UE may perform the KPI reporting. Further, after transmitting the first KPI report, the UE may refrain from transmitting the second KPI report until the timer expires.

As shown by reference number 610, the network node may adjust a density of the low-density reference signal pattern based at least in part on the report. For example, the network node may increase the low-density reference signal pattern based at least in part on the report, which may improve a channel estimation performance of the UE. Alternatively, the network node may decrease the density of the low-density reference signal pattern based at least in part on the report, which may reduce a signaling overhead between the UE and the network node.

In some aspects, the UE may monitor a current configured reference signal pattern density by cross-checking the channel measurements associated with the inference-based channel estimation and the channel measurements associated with the performance monitoring. As a result, the UE may be able to determine whether the current configured reference signal pattern density is sufficient or insufficient to achieve a channel estimation performance that satisfies the threshold.

As indicated above, FIG. 6 is provided as an example. Other examples may differ from what is described with regard to FIG. 6.

As an example, a channel estimation neural network may be trained with a certain low-density CSI-RS pattern (e.g., a non-uniform and RB-specific low-density CSI-RS pattern). The channel estimation neural network may be trained using 32 antenna ports (e.g., Ű=32), 48 RBs (e.g., Ű=48), a CSI-RS density of 0.125, and a signal-to-noise ratio (SNR) of 20 decibels (dB). The channel estimation neural network may be tested using 1140 samples. When using normalized mean square error (NMSE) as an evaluation metric (e.g., ∥ [symbol] − [symbol] ∥²/∥ [symbol] ∥²), a per-sample NMSE performance may be calculated. For a sample (or sample index) with relatively good NMSE (e.g., 0 to 0.1), a channel may be recovered with relatively high quality.

However, for a sample with relatively poor NMSE (e.g., 0.3 or more), a channel may not be recovered or may be recovered with relatively poor quality. In this case, the channel may be unable to be recovered using the low-density CSI-RS pattern. In this example, approximately 20% of samples may have an NMSE greater than 0.1, and the CSI-RS density may be insufficient to result in a decent channel estimation performance for these samples.

In the example, the channel may be divided into a first part channel ( [symbol] ₁) and a second part channel ( [symbol] ₂). The first part channel may be a channel that has CSI-RS observations. An NMSE of the first part channel (e.g., part 1 NMSE) may be calculated in accordance with: ∥ [symbol] ₁− [symbol] ₁∥²/∥ [symbol] ₁∥². The second part channel may be a channel that does not have CSI-RS observations. An NMSE of the second part channel (e.g., part 2 NMSE) may be calculated in accordance with: ∥ [symbol] ₂− [symbol] ₂∥²/∥ [symbol] ₂∥².

In the example, testing samples may be divided into two testing sets. A first testing set may include samples that have an overall NMSE that is less than or equal to 0.1 (e.g., NMSE≤0.1), which may correspond to approximately 80% of the samples.

The first testing set may correspond to an NMSE of a first part channel and an NMSE of a second part channel. A second testing set may include samples that have an overall NMSE that is greater than 0.1 (e.g., NMSE≥0.1), which may correspond to approximately 20% of the samples. The second testing set may correspond to an NMSE of a first part channel and an NMSE of a second part channel. For an NMSE of a first part channel, cumulative distribution functions (CDFs) between the first testing set and the second testing set may be relatively similar. For an NMSE of a second part channel, CDFs between the first testing set and the second testing set may be relatively different. Thus, the NMSE of the second part channel may be used to determine whether a sample has a sufficient CSI-RS density. For example, when an NMSE value equals 0.64 for part 2 (90% of cases), there is an approximately 86% chance that this sample is from a second testing set and an approximately 14% chance that this sample is from the first testing set.

In the example, the CSI-RS density may be increased, which may result in a CSI-RS pattern having a slightly higher CSI-RS density. Measurements [symbol] may be partitioned into two parts, where a first part [symbol] (e.g., E-part [symbol] ) may include measurements to be used for channel estimation (or channel inference), and a second part [symbol] (e.g., M-part [symbol] ) may include measurements to be used for monitoring (or validation). In this case, [symbol] may not be used for channel estimation. The measurements associated with monitoring may be used to check the measurements associated with channel estimation. In other words, samples may be partitioned into different parts in order to perform cross-validation. An NMSE of the first part [symbol] may be calculated in accordance with: ∥ [symbol] − [symbol] ∥²/∥ [symbol] ∥², where [symbol] is an estimated channel corresponding to RBs used for channel estimation. An NMSE of the second part [symbol] may be calculated in accordance with: ∥ [symbol] − [symbol] ∥²/∥ [symbol] ∥², where [symbol] is an estimated channel corresponding to RBs used for monitoring.

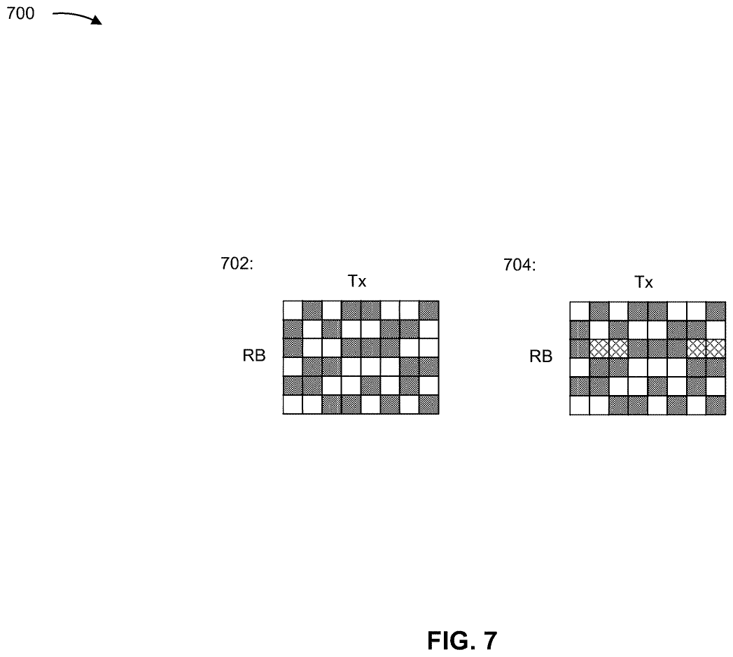

FIG. 7 is a diagram illustrating an example 700 associated with performance monitoring associated with low-density reference signal patterns, in accordance with the present disclosure.

As shown by reference number 702, a first CSI-RS pattern may be associated with a first density. As shown by reference number 704, a second CSI-RS pattern may be associated with a second density, where the second density may be higher than the first density. For example, the second CSI-RS pattern may be associated with a few additional RBs associated with CSI-RS, as compared to the first CSI-RS pattern. The few additional RBs may be used for monitoring, whereas other RBs associated with CSI-RS may be used for channel estimation. The few additional RBs used for monitoring may be for cross-checking or validating the other RBs used for channel estimation.

As indicated above, FIG. 7 is provided as an example. Other examples may differ from what is described with regard to FIG. 7.

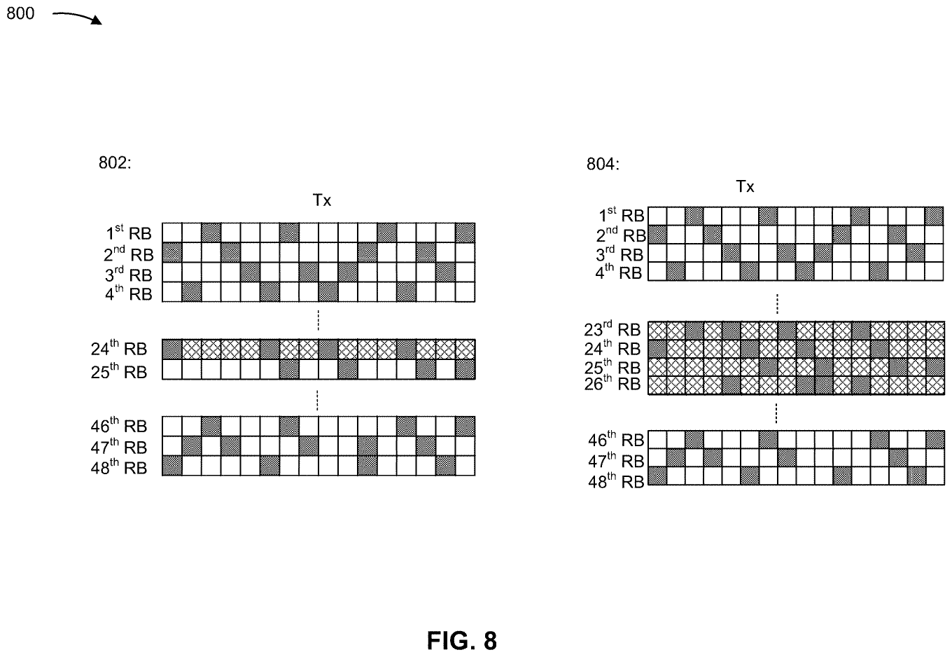

FIG. 8 is a diagram illustrating an example 800 associated with performance monitoring associated with low-density reference signal patterns, in accordance with the present disclosure.

As shown by reference number 802, a first CSI-RS pattern may be associated with a first increased density. For example, all 32 ports for a 24^{th} RB may be selected, which may result in a CSI-RS density of approximately 0.1432. As shown by reference number 804, a second CSI-RS pattern may be associated with a second increased density. For example, all 32 ports for a 23^{rd} RB, a 24^{th} RB, a 25^{th} RB, and a 26^{th} RB may be selected, which may result in a CSI-RS density of approximately 0.1979.

Further, when an M-part NMSE value equals 0.3(80 % of cases for a second testing set), there is an approximately 81% chance that this sample is from the second testing set and an approximately 19% chance that this sample is from a first testing set.

As indicated above, FIG. 8 is provided as an example. Other examples may differ from what is described with regard to FIG. 8.

FIG. 9 is a diagram illustrating an example 900 associated with performance monitoring associated with low-density reference signal patterns, in accordance with the present disclosure.

In some aspects, one resource may be associated with one CSI-RS occasion.

A UE may use a partial resource (e.g., a portion of the one resource) for channel estimation (or inference). The UE may use a remaining resource (e.g., a remaining portion of the one resource) for monitoring. The UE may calculate a KPI based at least in part on NMSE(″O−″O), where ″O is associated with an estimated monitored channel and ″O is associated with a monitored channel.

As shown in FIG. 9, one resource (or CSI-RS occasion) may be associated with channel estimation and monitoring. The one resource may be divided into a first portion and a second portion, where the first portion of the one resource may include RBs associated with channel estimation and the second portion of the one resource may include RBs associated with monitoring. CSI-RS measurements associated with the first portion of the one resource may be provided to a channel estimator (CE) of a UE. The UE, via the CE, may determine the estimated monitored channel (″O) based at least in part on the CSI-RS measurements associated with the first portion of the one resource. The UE may determine the monitored channel (″O) based at least in part on CSI-RS measurements associated with the second portion of the one resource.

The UE may perform a KPI calculation based at least in part on ″O and ″O in order to obtain a KPI.

As indicated above, FIG. 9 is provided as an example. Other examples may differ from what is described with regard to FIG. 9.

FIG. 10 is a diagram illustrating an example 1000 associated with performance monitoring associated with low-density reference signal patterns, in accordance with the present disclosure.

In some aspects, a first resource may be associated with channel estimation (or inference) and a second resource may be associated with monitoring. The second resource for monitoring may contain physical resources that are not included in the first resource for channel estimation (e.g., a monitoring resource may at least contain physical resources that are not included in an inference resource). The UE may calculate a KPI based at least in part on NMSE(″O−″O) . In some aspects, a configuration or an association of the two resources may be independent or paired. In other words, the first resource may be independent from the second resource, or alternatively, the first resource may be paired with the second resource.

As shown by reference number 1002, a first resource may be associated with channel estimation, and a second resource may be associated with monitoring. The first resource may include RBs associated with channel estimation and the second resource may include RBs associated with monitoring. CSI-RS measurements associated with the first resource may be provided to a CE of a UE. The UE, via the CE, may determine the estimated monitored channel (″O) based at least in part on the CSI-RS measurements associated with the first resource. The UE may determine the monitored channel (″O) based at least in part on CSI-RS measurements associated with the second resource. The UE may perform a KPI calculation based at least in part on ″O and ″O in order to obtain a KPI.

As shown by reference number 1004, the first resource for channel estimation may be independent of the second resource for monitoring. An association of the first resource for channel estimation and the second resource for monitoring may be independent. The first resource for channel estimation may be associated with a first pattern, and the second resource for monitoring may be associated with a second pattern.

As shown by reference number 1006, the first resource for channel estimation may be paired with the second resource for monitoring. An association of the first resource for channel estimation and the second resource for monitoring may be paired. The second resource for monitoring may be associated with a second pattern, which may be relative to a first pattern associated with the first resource for channel estimation.

As indicated above, FIG. 10 is provided as an example. Other examples may differ from what is described with regard to FIG. 10.

FIG. 11 is a diagram illustrating an example 1100 associated with performance monitoring associated with low-density reference signal patterns, in accordance with the present disclosure.

In some aspects, one resource for channel estimation (or inference) and a proxy model may be used to output a KPI. An input of the proxy model for KPI calculation may be an estimated channel (″O) or a latent output.

As shown in FIG. 11, one resource may be associated with channel estimation. CSI-RS measurements associated with the one resource may be provided to a CE of a UE. The UE, via the CE, may determine an estimated channel (″O) or a latent output, which may be an input to a proxy model. The UE may calculate, based at least in part on the input of the estimated channel or the latent output to the proxy model, a KPI.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120) performs operations associated with performance monitoring associated with low-density reference signal patterns.

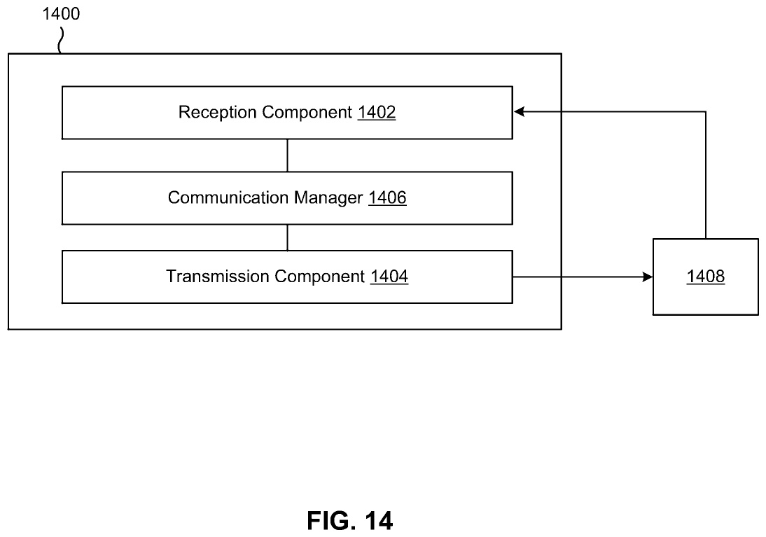

As shown in FIG. 12, in some aspects, process 1200 may include obtaining channel measurements associated with one or more measurement resources, wherein the one or more measurement resources are associated with a low-density reference signal pattern, and the one or more measurement resources are associated with one or more of an inference-based channel estimation or a performance monitoring (block 1210). For example, the UE (e.g., using reception component 1402 and/or communication manager 1406, depicted in FIG. 14) may obtain channel measurements associated with one or more measurement resources, wherein the one or more measurement resources are associated with a low-density reference signal pattern, and the one or more measurement resources are associated with one or more of an inference-based channel estimation or a performance monitoring, as described above.

As further shown in FIG. 12, in some aspects, process 1200 may include determining a KPI based at least in part on the channel measurements (block 1220). For example, the UE (e.g., using communication manager 1406, depicted in FIG. 14) may determine a KPI based at least in part on the channel measurements, as described above.

As further shown in FIG. 12, in some aspects, process 1200 may include transmitting a report that indicates one or more of the KPI or the channel measurements (block 1230). For example, the UE (e.g., using transmission component 1404 and/or communication manager 1406, depicted in FIG. 14) may transmit a report that indicates one or more of the KPI or the channel measurements, as described above.

Process 1200 may include additional aspects, such as any single aspect or any combination of aspects described below and/or in connection with one or more other processes described elsewhere herein.

In a first aspect, the one or more measurement resources are CSI-RS resources, and the low-density reference signal pattern is a low-density CSI-RS pattern.

In a second aspect, alone or in combination with the first aspect, the one or more measurement resources include a single resource associated with the inference-based channel estimation and the performance monitoring, wherein a first portion of the single resource is associated with the inference-based channel estimation and a remaining portion of the single resource is associated with the performance monitoring.

In a third aspect, alone or in combination with one or more of the first and second aspects, process 1200 includes determining the KPI based at least in part on channel measurements associated with the first portion of the single resource and channel measurements associated with the remaining portion of the single resource.

In a fourth aspect, alone or in combination with one or more of the first through third aspects, the one or more measurement resources include a first resource associated with the inference-based channel estimation and a second resource associated with the performance monitoring.

In a fifth aspect, alone or in combination with one or more of the first through fourth aspects, process 1200 includes determining the KPI based at least in part on channel measurements associated with the first resource and channel measurements associated with the second resource.

In a sixth aspect, alone or in combination with one or more of the first through fifth aspects, the second resource includes physical resources that are not included in the first resource.

In a seventh aspect, alone or in combination with one or more of the first through sixth aspects, the first resource is independent from the second resource.

In an eighth aspect, alone or in combination with one or more of the first through seventh aspects, the first resource is paired with the second resource.

In a ninth aspect, alone or in combination with one or more of the first through eighth aspects, the KPI is based at least in part on an NMSE associated with the channel measurements.

In a tenth aspect, alone or in combination with one or more of the first through ninth aspects, the one or more measurement resources include a single resource associated with only the inference-based channel estimation.

In an eleventh aspect, alone or in combination with one or more of the first through tenth aspects, process 1200 includes determining the KPI based at least in part on channel measurements associated with the single resource and a proxy model.

In a twelfth aspect, alone or in combination with one or more of the first through eleventh aspects, the report includes one or more of the KPI, the channel measurements, CSI derived from the channel measurements, or a one-bit indication that indicates whether a density of the low-density reference signal pattern satisfies a threshold.

In a thirteenth aspect, alone or in combination with one or more of the first through twelfth aspects, the low-density reference signal pattern is one of a non-uniform and RB-common pattern, a non-uniform and RB-specific pattern, a uniform and RB-common pattern, or a uniform and RB-specific pattern, and the low-density reference signal pattern includes RBs associated with reference signal observations and RBs that are not associated with reference signal observations.

In a fourteenth aspect, alone or in combination with one or more of the first through thirteenth aspects, the report is a network-node-controlled report, and the report is one of a periodic report, a semi-persistent report, or an aperiodic report.

In a fifteenth aspect, alone or in combination with one or more of the first through fourteenth aspects, the report is a UE-initiated report or an event-triggered report.

In a sixteenth aspect, alone or in combination with one or more of the first through fifteenth aspects, the event-triggered report is based at least in part on the KPI satisfying a threshold, and the threshold is configured by a network node or predefined in a standard.

In a seventeenth aspect, alone or in combination with one or more of the first through sixteenth aspects, the event-triggered report is based at least in part on a number of events, in which the KPI is below a first threshold, satisfying a second threshold.

In an eighteenth aspect, alone or in combination with one or more of the first through seventeenth aspects, the report is a first report, and process 1200 includes refraining from transmitting a second report until an expiry of a timer.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 110) performs operations associated with performance monitoring associated with low-density reference signal patterns.

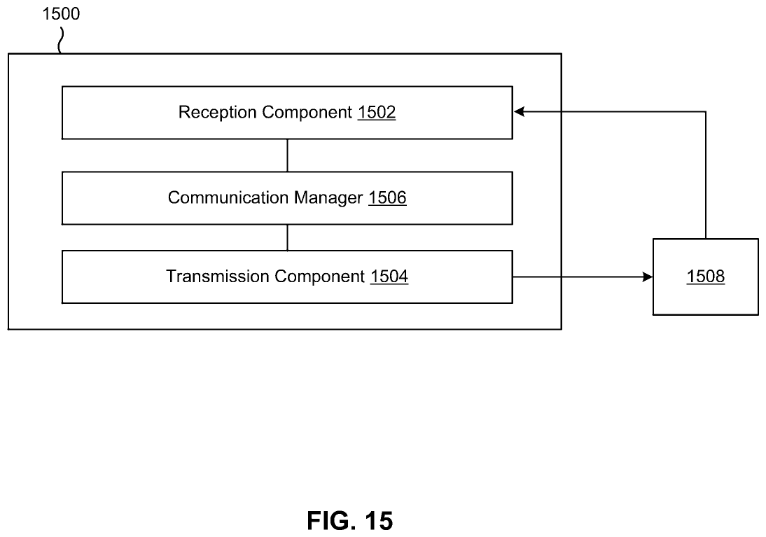

As shown in FIG. 13, in some aspects, process 1300 may include transmitting a reference signal in accordance with a low-density reference signal pattern, wherein the reference signal is associated with one or more measurement resources, and the one or more measurement resources are associated with one or more of an inference-based channel estimation or a performance monitoring (block 1310). For example, the network node (e.g., using transmission component 1504 and/or communication manager 1506, depicted in FIG. 15) may transmit a reference signal in accordance with a low-density reference signal pattern, wherein the reference signal is associated with one or more measurement resources, and the one or more measurement resources are associated with one or more of an inference-based channel estimation or a performance monitoring, as described above.

As further shown in FIG. 13, in some aspects, process 1300 may include receiving a report that indicates a KPI associated with channel measurements, wherein the channel measurements are associated with the one or more measurement resources (block 1320). For example, the network node (e.g., using reception component 1502 and/or communication manager 1506, depicted in FIG. 15) may receive a report that indicates a KPI associated with channel measurements, wherein the channel measurements are associated with the one or more measurement resources, as described above.

Process 1300 may include additional aspects, such as any single aspect or any combination of aspects described below and/or in connection with one or more other processes described elsewhere herein.

In a first aspect, the one or more measurement resources are CSI-RS resources, and the low-density reference signal pattern is a low-density CSI-RS pattern.

In a second aspect, alone or in combination with the first aspect, the one or more measurement resources include a single resource associated with the inference-based channel estimation and the performance monitoring, wherein a first portion of the single resource is associated with the inference-based channel estimation and a remaining portion of the single resource is associated with the performance monitoring.

In a third aspect, alone or in combination with one or more of the first and second aspects, the KPI is based at least in part on channel measurements associated with the first portion of the single resource and channel measurements associated with the remaining portion of the single resource.

In a fourth aspect, alone or in combination with one or more of the first through third aspects, the one or more measurement resources include a first resource associated with the inference-based channel estimation and a second resource associated with the performance monitoring.

In a fifth aspect, alone or in combination with one or more of the first through fourth aspects, the KPI is based at least in part on channel measurements associated with the first resource and channel measurements associated with the second resource.

In a sixth aspect, alone or in combination with one or more of the first through fifth aspects, the second resource includes physical resources that are not included in the first resource.

In a seventh aspect, alone or in combination with one or more of the first through sixth aspects, the first resource is independent from the second resource.

In an eighth aspect, alone or in combination with one or more of the first through seventh aspects, the first resource is paired with the second resource.

In a ninth aspect, alone or in combination with one or more of the first through eighth aspects, the KPI is based at least in part on an NMSE associated with the channel measurements.

In a tenth aspect, alone or in combination with one or more of the first through ninth aspects, the one or more measurement resources include a single resource associated with only the inference-based channel estimation.

In an eleventh aspect, alone or in combination with one or more of the first through tenth aspects, the KPI is based at least in part on channel measurements associated with the single resource and a proxy model.

In a twelfth aspect, alone or in combination with one or more of the first through eleventh aspects, the report includes one or more of the KPI, the channel measurements, CSI derived from the channel measurements, or a one-bit indication that indicates whether a density of the low-density reference signal pattern satisfies a threshold.

In a thirteenth aspect, alone or in combination with one or more of the first through twelfth aspects, the low-density reference signal pattern is one of a non-uniform and RB-common pattern, a non-uniform and RB-specific pattern, a uniform and RB-common pattern, or a uniform and RB-specific pattern, and the low-density reference signal pattern includes RBs associated with reference signal observations and RBs that are not associated with reference signal observations.

In a fourteenth aspect, alone or in combination with one or more of the first through thirteenth aspects, the report is a network-node-controlled report, and the report is one of a periodic report, a semi-persistent report, or an aperiodic report.

In a fifteenth aspect, alone or in combination with one or more of the first through fourteenth aspects, the report is a UE-initiated report or an event-triggered report.

In a sixteenth aspect, alone or in combination with one or more of the first through fifteenth aspects, the event-triggered report is based at least in part on the KPI satisfying a threshold, and the threshold is configured by the network node or predefined in a standard.

In a seventeenth aspect, alone or in combination with one or more of the first through sixteenth aspects, the event-triggered report is based at least in part on a number of events, in which the KPI is below a first threshold, satisfying a second threshold.

In an eighteenth aspect, alone or in combination with one or more of the first through seventeenth aspects, the report is a first report, and a second report is not received until an expiry of a timer.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 140 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 6-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the UE described in connection with FIG. 2.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, a modem, a modulator, a transmit MIMO processor, a transmit processor, a controller/processor, a memory, or a combination thereof, of the UE described in connection with FIG. 2. In some aspects, the transmission component 1404 may be co-located with the reception component 1402 in a transceiver.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The communication manager 1406 may obtain channel measurements associated with one or more measurement resources, wherein the one or more measurement resources are associated with a low-density reference signal pattern, and the one or more measurement resources are associated with one or more of an inference-based channel estimation or a performance monitoring. The communication manager 1406 may determine a KPI based at least in part on the channel measurements. The transmission component 1404 may transmit a report that indicates one or more of the KPI or the channel measurements.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 6-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the network node described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the network node described in connection with FIG. 2. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, a modem, a modulator, a transmit MIMO processor, a transmit processor, a controller/processor, a memory, or a combination thereof, of the network node described in connection with FIG. 2. In some aspects, the transmission component 1504 may be co-located with the reception component 1502 in a transceiver.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit a reference signal in accordance with a low-density reference signal pattern, wherein the reference signal is associated with one or more measurement resources, and the one or more measurement resources are associated with one or more of an inference-based channel estimation or a performance monitoring. The reception component 1502 may receive a report that indicates a KPI associated with channel measurements, wherein the channel measurements are associated with the one or more measurement resources.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: obtaining channel measurements associated with one or more measurement resources, wherein the one or more measurement resources are associated with a low-density reference signal pattern, and the one or more measurement resources are associated with one or more of an inference-based channel estimation or a performance monitoring; determining a key performance indicator (KPI) based at least in part on the channel measurements; and transmitting a report that indicates one or more of the KPI or the channel measurements.

Aspect 2: The method of Aspect 1, wherein the one or more measurement resources are channel state information reference signal (CSI-RS) resources, and the low-density reference signal pattern is a low-density CSI-RS pattern.

Aspect 3: The method of any of Aspects 1-2, wherein the one or more measurement resources include a single resource associated with the inference-based channel estimation and the performance monitoring, wherein a first portion of the single resource is associated with the inference-based channel estimation and a remaining portion of the single resource is associated with the performance monitoring.

Aspect 4: The method of Aspect 3, wherein determining the KPI comprises determining the KPI based at least in part on channel measurements associated with the first portion of the single resource and channel measurements associated with the remaining portion of the single resource.

Aspect 5: The method of any of Aspects 1-4, wherein the one or more measurement resources include a first resource associated with the inference-based channel estimation and a second resource associated with the performance monitoring.

Aspect 6: The method of Aspect 5, wherein determining the KPI comprises determining the KPI based at least in part on channel measurements associated with the first resource and channel measurements associated with the second resource.

Aspect 7: The method of Aspect 5, wherein the second resource includes physical resources that are not included in the first resource.

Aspect 8: The method of Aspect 5, wherein the first resource is independent from the second resource.

Aspect 9: The method of Aspect 5, wherein the first resource is paired with the second resource.

Aspect 10: The method of any of Aspects 1-9, wherein the KPI is based at least in part on a normalized mean square error (NMSE) associated with the channel measurements.

Aspect 11: The method of any of Aspects 1-10, wherein the one or more measurement resources include a single resource associated with only the inference-based channel estimation.

Aspect 12: The method of Aspect 11, wherein determining the KPI comprises determining the KPI based at least in part on channel measurements associated with the single resource and a proxy model.

Aspect 13: The method of any of Aspects 1-12, wherein the report includes one or more of: the KPI, the channel measurements, channel state information (CSI) derived from the channel measurements, or a one-bit indication that indicates whether a density of the low-density reference signal pattern satisfies a threshold.

Aspect 14: The method of any of Aspects 1-13, wherein the low-density reference signal pattern is one of: a non-uniform and resource block (RB)-common pattern, a non-uniform and RB-specific pattern, a uniform and RB-common pattern, or a uniform and RB-specific pattern, and the low-density reference signal pattern includes RBs associated with reference signal observations and RBs that are not associated with reference signal observations.

Aspect 15: The method of any of Aspects 1-14, wherein the report is a network-node-controlled report, and the report is one of: a periodic report, a semi-persistent report, or an aperiodic report.

Aspect 16: The method of any of Aspects 1-15, wherein the report is a UE-initiated report or an event-triggered report.

Aspect 17: The method of Aspect 16, wherein the event-triggered report is based at least in part on the KPI satisfying a threshold, and the threshold is configured by a network node or predefined in a standard.

Aspect 18: The method of Aspect 16, wherein the event-triggered report is based at least in part on a number of events in which the KPI is below a first threshold satisfying a second threshold.

Aspect 19: The method of any of Aspects 1-18, wherein the report is a first report, and further comprising: refraining from transmitting a second report until an expiry of a timer.

Aspect 20: A method of wireless communication performed by a network node, comprising: transmitting a reference signal in accordance with a low-density reference signal pattern, wherein the reference signal is associated with one or more measurement resources, and the one or more measurement resources are associated with one or more of an inference-based channel estimation or a performance monitoring; and receiving a report that indicates a key performance indicator (KPI) associated with channel measurements, wherein the channel measurements are associated with the one or more measurement resources.

Aspect 21: The method of Aspect 20, wherein the one or more measurement resources are channel state information reference signal (CSI-RS) resources, and the low-density reference signal pattern is a low-density CSI-RS pattern.

Aspect 22: The method of any of Aspects 20-21, wherein the one or more measurement resources include a single resource associated with the inference-based channel estimation and the performance monitoring, wherein a first portion of the single resource is associated with the inference-based channel estimation and a remaining portion of the single resource is associated with the performance monitoring.

Aspect 23: The method of Aspect 22, wherein the KPI is based at least in part on channel measurements associated with the first portion of the single resource and channel measurements associated with the remaining portion of the single resource.

Aspect 24: The method of any of Aspects 20-23, wherein the one or more measurement resources include a first resource associated with the inference-based channel estimation and a second resource associated with the performance monitoring.

Aspect 25: The method of Aspect 24, wherein the KPI is based at least in part on channel measurements associated with the first resource and channel measurements associated with the second resource.

Aspect 26: The method of Aspect 24, wherein the second resource includes physical resources that are not included in the first resource.

Aspect 27: The method of Aspect 24, wherein the first resource is independent from the second resource.

Aspect 28: The method of Aspect 24, wherein the first resource is paired with the second resource.

Aspect 29: The method of any of Aspects 20-28, wherein the KPI is based at least in part on a normalized mean square error (NMSE) associated with the channel measurements.

Aspect 30: The method of any of Aspects 20-29, wherein the one or more measurement resources include a single resource associated with only the inference-based channel estimation.

Aspect 31: The method of Aspect 30, wherein the KPI is based at least in part on channel measurements associated with the single resource and a proxy model.

Aspect 32: The method of any of Aspects 20-31, wherein the report includes one or more of: the KPI, the channel measurements, channel state information (CSI) derived from the channel measurements, or a one-bit indication that indicates whether a density of the low-density reference signal pattern satisfies a threshold.

Aspect 33: The method of any of Aspects 20-32, wherein the low-density reference signal pattern is one of: a non-uniform and resource block (RB)-common pattern, a non-uniform and RB-specific pattern, a uniform and RB-common pattern, or a uniform and RB-specific pattern, and the low-density reference signal pattern includes RBs associated with reference signal observations and RBs that are not associated with reference signal observations.

Aspect 34: The method of any of Aspects 20-33, wherein the report is a network-node-controlled report, and the report is one of: a periodic report, a semi-persistent report, or an aperiodic report.

Aspect 35: The method of any of Aspects 20-34, wherein the report is a user equipment (UE)-initiated report or an event-triggered report.

Aspect 36: The method of Aspect 35, wherein the event-triggered report is based at least in part on the KPI satisfying a threshold, and the threshold is configured by the network node or predefined in a standard.

Aspect 37: The method of Aspect 35, wherein the event-triggered report is based at least in part on a number of events in which the KPI is below a first threshold satisfying a second threshold.

Aspect 38: The method of any of Aspects 20-37, wherein the report is a first report, and a second report is not received until an expiry of a timer.

Aspect 39: An apparatus for wireless communication at a device, comprising a processor; memory coupled with the processor; and instructions stored in the memory and executable by the processor to cause the apparatus to perform the method of one or more of Aspects 1-19.

Aspect 40: A device for wireless communication, comprising a memory and one or more processors coupled to the memory, the one or more processors configured to perform the method of one or more of Aspects 1-19.

Aspect 41: An apparatus for wireless communication, comprising at least one means for performing the method of one or more of Aspects 1-19.

Aspect 42: A non-transitory computer-readable medium storing code for wireless communication, the code comprising instructions executable by a processor to perform the method of one or more of Aspects 1-19.

Aspect 43: A non-transitory computer-readable medium storing a set of instructions for wireless communication, the set of instructions comprising one or more instructions that, when executed by one or more processors of a device, cause the device to perform the method of one or more of Aspects 1-19.

Aspect 44: An apparatus for wireless communication at a device, comprising a processor; memory coupled with the processor; and instructions stored in the memory and executable by the processor to cause the apparatus to perform the method of one or more of Aspects 20-38.

Aspect 45: A device for wireless communication, comprising a memory and one or more processors coupled to the memory, the one or more processors configured to perform the method of one or more of Aspects 20-38.

Aspect 46: An apparatus for wireless communication, comprising at least one means for performing the method of one or more of Aspects 20-38.

Aspect 47: A non-transitory computer-readable medium storing code for wireless communication, the code comprising instructions executable by a processor to perform the method of one or more of Aspects 20-38.

Aspect 48: A non-transitory computer-readable medium storing a set of instructions for wireless communication, the set of instructions comprising one or more instructions that, when executed by one or more processors of a device, cause the device to perform the method of one or more of Aspects 20-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a +a, a +a +a, a +a +b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a user equipment (UE), comprising:
one or more memories; and
one or more processors coupled to the one or more memories, the one or more processors individually or collectively configured to:
obtain channel measurements associated with one or more measurement resources, wherein the one or more measurement resources are associated with a low-density reference signal pattern, and the one or more measurement resources are associated with one or more of an inference-based channel estimation or a performance monitoring;
determine a key performance indicator (KPI) based at least in part on the channel measurements; and
transmit a report that indicates one or more of the KPI or the channel measurements.

2. The apparatus of claim 1, wherein the one or more measurement resources are channel state information reference signal (CSI-RS) resources, and the low-density reference signal pattern is a low-density CSI-RS pattern.

3. The apparatus of claim 1, wherein the one or more measurement resources include a single resource associated with the inference-based channel estimation and the performance monitoring, wherein a first portion of the single resource is associated with the inference-based channel estimation and a remaining portion of the single resource is associated with the performance monitoring.

4. The apparatus of claim 3, wherein the one or more processors are individually or collectively configured to determine the KPI based at least in part on channel measurements associated with the first portion of the single resource and channel measurements associated with the remaining portion of the single resource.

5. The apparatus of claim 1, wherein the one or more measurement resources include a first resource associated with the inference-based channel estimation and a second resource associated with the performance monitoring.

6. The apparatus of claim 5, wherein the one or more processors are individually or collectively configured to determine the KPI based at least in part on channel measurements associated with the first resource and channel measurements associated with the second resource.

7. (canceled)

8. (canceled)

9. (canceled)

10. The apparatus of claim 1, wherein the KPI is based at least in part on a normalized mean square error (NMSE) associated with the channel measurements.

11. The apparatus of claim 1, wherein the one or more measurement resources include a single resource associated with only the inference-based channel estimation.

12. The apparatus of claim 11, wherein the one or more processors are individually or collectively configured to determine the KPI based at least in part on channel measurements associated with the single resource and a proxy model.

13. The apparatus of claim 1, wherein the report includes one or more of: the KPI, the channel measurements, channel state information (CSI) derived from the channel measurements, or a one-bit indication that indicates whether a density of the low-density reference signal pattern satisfies a threshold.

14. The apparatus of claim 1, wherein the low-density reference signal pattern is one of: a non-uniform and resource block (RB)-common pattern, a non-uniform and RB-specific pattern, a uniform and RB-common pattern, or a uniform and RB-specific pattern, and the low-density reference signal pattern includes RBs associated with reference signal observations and RBs that are not associated with reference signal observations.

15. The apparatus of claim 1, wherein the report is a network-node-controlled report, and the report is one of: a periodic report, a semi-persistent report, or an aperiodic report.

16. The apparatus of claim 1, wherein the report is a UE-initiated report or an event-triggered report.

17. The apparatus of claim 16, wherein the event-triggered report is based at least in part on the KPI satisfying a threshold, and the threshold is configured by a network node or predefined in a standard.

18. The apparatus of claim 16, wherein the event-triggered report is based at least in part on a number of events in which the KPI is below a first threshold satisfying a second threshold.

19. The apparatus of claim 1, wherein the report is a first report, and the one or more processors are individually or collectively configured to:
refrain from transmitting a second report until an expiry of a timer.

20. An apparatus for wireless communication at a network node, comprising:
one or more memories; and
one or more processors coupled to the one or more memories, the one or more processors individually or collectively configured to:
transmit a reference signal in accordance with a low-density reference signal pattern, wherein the reference signal is associated with one or more measurement resources, and the one or more measurement resources are associated with one or more of an inference-based channel estimation or a performance monitoring; and
receive a report that indicates a key performance indicator (KPI) associated with channel measurements, wherein the channel measurements are associated with the one or more measurement resources.

21. The apparatus of claim 20, wherein the one or more measurement resources are channel state information reference signal (CSI-RS) resources, and the low-density reference signal pattern is a low-density CSI-RS pattern.

22. The apparatus of claim 20, wherein the one or more measurement resources include a single resource associated with the inference-based channel estimation and the performance monitoring, a first portion of the single resource is associated with the inference-based channel estimation and a remaining portion of the single resource is associated with the performance monitoring, and the KPI is based at least in part on channel measurements associated with the first portion of the single resource and channel measurements associated with the remaining portion of the single resource.

23.-28 (canceled)

29. A method of wireless communication performed by a user equipment (UE), comprising:
obtaining channel measurements associated with one or more measurement resources, wherein the one or more measurement resources are associated with a low-density reference signal pattern, and the one or more measurement resources are associated with one or more of an inference-based channel estimation or a performance monitoring;
determining a key performance indicator (KPI) based at least in part on the channel measurements; and
transmitting a report that indicates one or more of the KPI or the channel measurements.

30. (canceled)
